(19) United States
(12) Patent Application Publication
(10) Pub. No.: US 2013/0129857 A1
(43) Pub. Date: May 23, 2013

(54) MOULD FOR INJECTION-MOULDING OF PLASTIC PARTS

(71) Applicant: Amedeo Bregolin, Torino (IT)

(72) Inventor: Amedeo Bregolin, Torino (IT)

(73) Assignee: H.C.M. STAMPI S.r.L., MONCALIERI(Torino) (IT)

(21) Appl. No.: 13/521,068

(22) PCT Filed: Jan. 28, 2011
(86) PCT No.: PCT/IB11/50373

§ 371 Date: Jul. 9, 2012

(30) Foreign Application Priority Data
Jan. 29, 2010 (IT) TO2010A000066

(51) Int. Cl. B29C 45/04

(52) U.S. Cl. CPC B29C 45/04
USPC 425/589

(57) ABSTRACT

Moulds for injection molding of plastic parts comprising a die and a punch which define, in the closed mould condition, a cavity intended to receive plastic material injected by a press are provided. The punch may comprise a central element and a pair of first lateral elements arranged on longitudinally opposite sides relative to the central element, each of the first lateral elements being slidably guided along a respective inclined lateral surface of the central element to be displaced between a moulding position and an ejection position.

The present invention relates to a mould for injection-moulding of plastic parts, in particular motor-vehicle parts, such as bumpers. The invention has been conceived, and will be described hereinbelow, with particular reference to a mould for injection-moulding of motor-vehicle bumpers, but it is clear that it is likewise applicable to a mould for injection-moulding of plastic parts of different type and use.

Conventionally, the moulds for injection-moulding of plastic parts are composed of an outer part, called die, and an inner part, called punch, the die and the punch defining, in the closed condition of the mould, a cavity inside which the plastic material for forming the finished part is injected by a press. In the particular case of moulds intended for the production of motor-vehicle bumpers, the punch is composed in turn of at least three separate elements, i.e. a central element and at least one pair of lateral elements arranged on opposite sides of the central element, the outer surfaces of these three elements defining the inner profile of the aforementioned cavity defined between the punch and the die. The lateral elements are mounted so as to be slidable with respect to the central element along respective inclined lateral surfaces of the latter and, once the mould is opened, they are pushed forwards (i.e. outwards) so as to disengage from projections or undercuts of the moulded part and thus allow release of the moulded part from the punch. In known moulds for injection-moulding of plastic parts, the punch is supported on a base plate by means of a support structure (commonly referred to by the term “trestle”) comprising a pair of spacers. A chamber is defined between the spacers of the support structure and slidably receives an extraction plate which is able to move with an alternating movement in the mould opening/closing direction. A linear actuation unit, conventionally of the hydraulic type, controls the movement of the extraction plate. Typically, the mould also comprises ejection members which are slidably arranged inside suitable holes provided in the central element of the punch and have the function of disengaging the punch from projections or undercuts of the moulded part so as to allow release of the latter from the mould. The ejection members are connected to the extraction plate so as to slide inside the respective holes as a result of the translational movement of the extraction plate. The extraction plate is also connected to the movable lateral elements of the punch by means of respective columns guided through respective inclined holes provided in a support body to which the central element of the punch is fixed, whereby the movable lateral elements of the punch move back and forth along with the extraction plate.

The known structure of the moulds for injection-moulding of plastic parts, as described above, has the disadvantage that the manufacture of the movable components of the mould is complicated and costly and that the punch and the inclined columns are subject, during moulding, to bending and deformation which have a negative effect on the quality of the moulded part.

A mould of the type indicated above is known, for example, from FR2809344. According to this known solution, both the ejection members (consisting in the present case of a single ejection block arranged in the central part of the punch) and the movable lateral elements of the punch are connected by means of respective rods to the extraction plate, which is translatable in the mould opening/closing direction and is operated by means of linear actuation devices formed as hydraulic cylinders. The movement both of the central ejection block and of the movable lateral elements is therefore controlled by the hydraulic cylinders via the extraction plate arranged in between. The fact that both the central ejection block and the movable lateral elements of the punch are operated via the extraction plate results in the mould having large overall sizes and moreover prevents operation of the movable lateral elements independently of the central ejection block.

The object of the present invention is to provide a mould for injection-moulding of plastic parts, in particular of motor-vehicle bumpers, which is not affected by the drawbacks of the prior art mentioned above and which in particular is simpler and more compact, has a low weight, can be manufactured at a lower cost and operates in a more flexible and reliable manner compared to the prior art.

This and other objects are fully achieved according to the present invention by means of a mould for injection-moulding of plastic parts, in particular of motor-vehicle bumpers, having the features defined in the characterizing part of the accompanying independent claim 1.

Further advantageous features of the present invention are specified in the dependent claims, the contents of which are to be understood as forming an integral and integrating part of the description which follows.

In short, the invention is based on the idea of providing a mould for injection-moulding of plastic parts, in particular of motor-vehicle bumpers, comprising a die, a punch formed by a stationary central element and by at least two lateral elements movable with respect to the central element, a base plate, a support body mounted on the base plate for supporting, in the closed mould condition, both the punch and the die, a plurality of ejection members slidably received inside respective holes provided in the central element of the punch, and an extraction plate received inside a chamber defined, in the mould opening/closing direction, between the support body and the base plate, the extraction plate being translatable in the mould opening/closing direction and being connected to the ejection members so as to control the sliding movement thereof inside the respective holes, wherein the two movable lateral elements of the punch are connected directly, i.e. without the extraction plate arranged in between, to respective linear actuation devices, such as hydraulic jacks, so as to be moved relative to the central element of the punch.

Differently from the prior art described above, therefore, according to the invention the lateral elements of the punch are not moved via the extraction plate, for example by means of inclined columns, but are directly moved by the respective linear actuation devices. The extraction plate may therefore have a smaller length compared to the prior art, preferably a length not greater than that of the central element of the punch, with the result that the chamber inside which the extraction plate is received will also have a correspondingly smaller length and therefore the assembly formed by the support body and by the central element of the punch, which in the region of the chamber is subject to bending as a result of its own weight and, during moulding, of the pressure of the plastic material injected into the mould cavity, will be subject to smaller deformations. The mould according to the invention allows therefore to obtain high-quality moulded parts. Moreover, the elimination of the inclined columns allows to simplify the structure of the mould and to reduce the cost thereof compared to the prior art.

Further features and advantages of the present invention will emerge more clearly from the following detailed description, provided purely by way of a non-limiting example, with reference to the accompanying drawings in which:

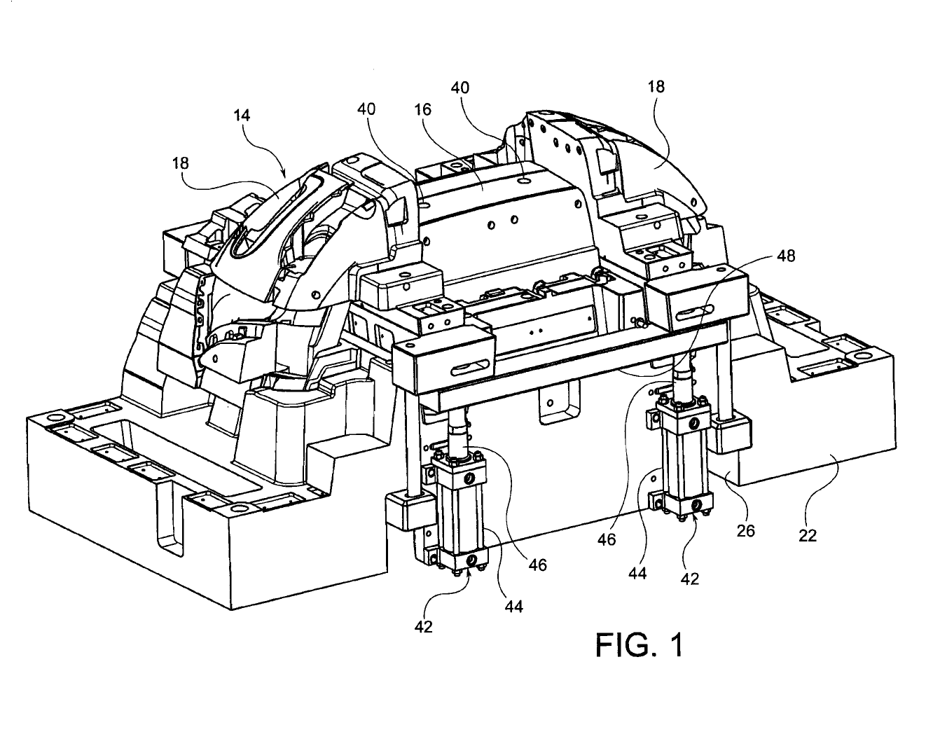

FIG. 1 is a perspective view of the punch of a mould for injection-moulding of plastic parts, in particular of motor-vehicle bumpers, according to a preferred embodiment of the present invention, the punch being shown in the ejection position;

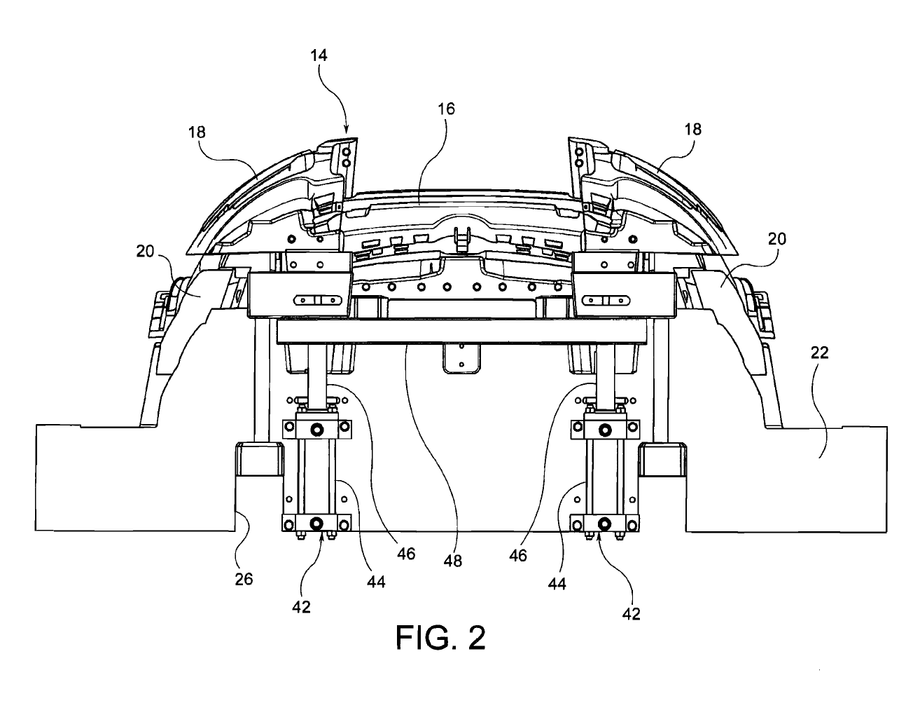

FIG. 2 is a front elevation view of the punch of FIG. 1;

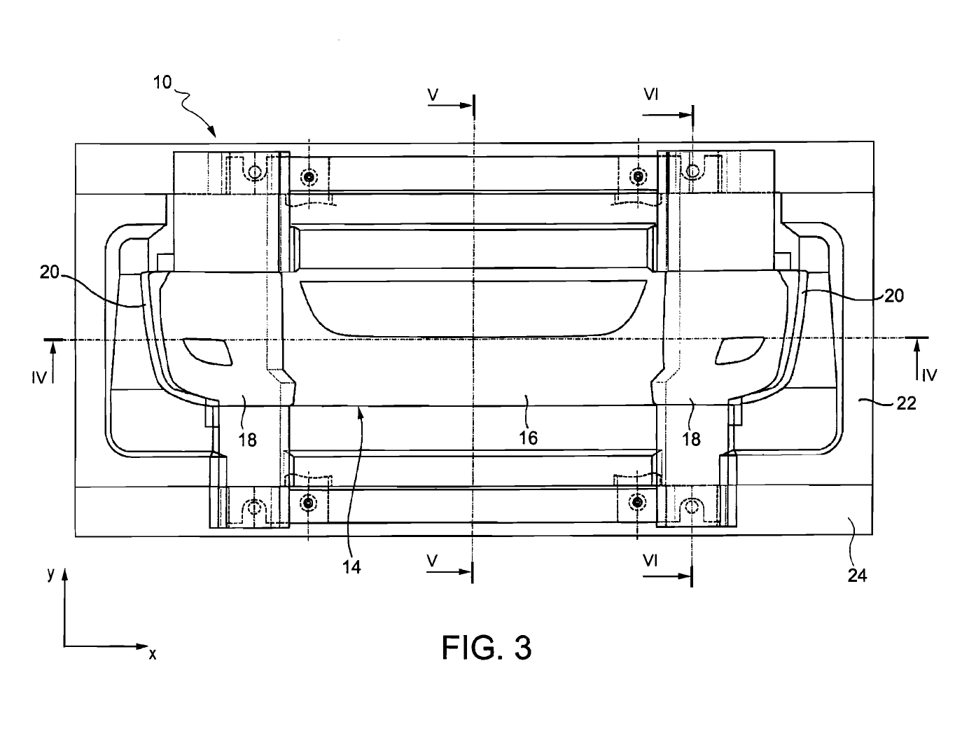

FIG. 3 is a top plan view of a mould for injection-moulding of plastic parts, in particular of motor-vehicle bumpers, according to a preferred embodiment of the present invention, the mould being shown without die;

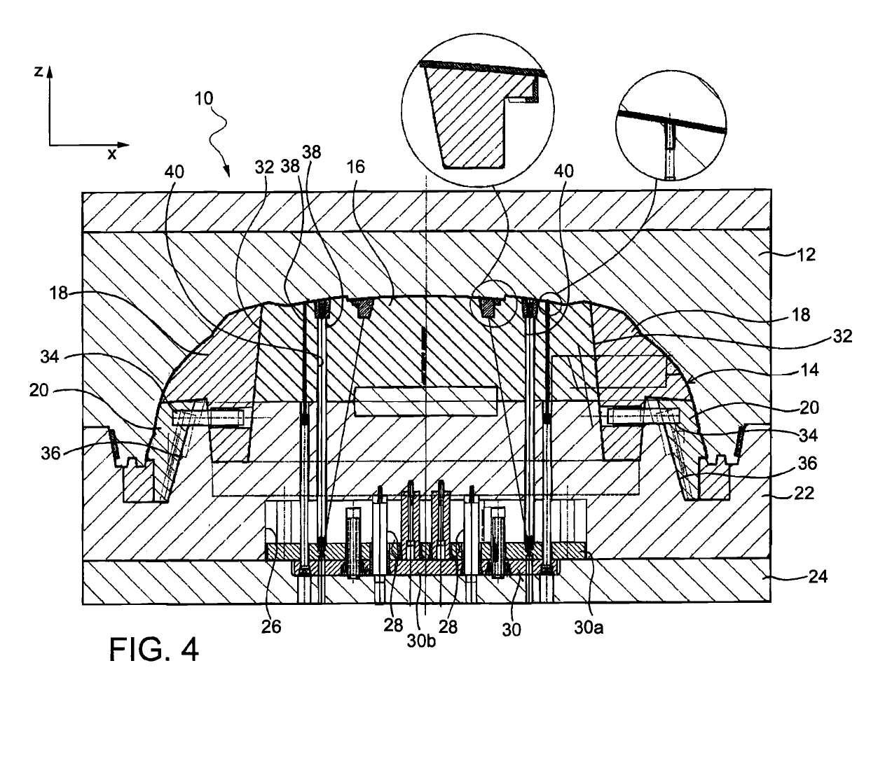

FIG. 4 shows the mould of FIG. 3 cross-sectioned through a longitudinal vertical plane indicated by IV-IV in FIG. 3;

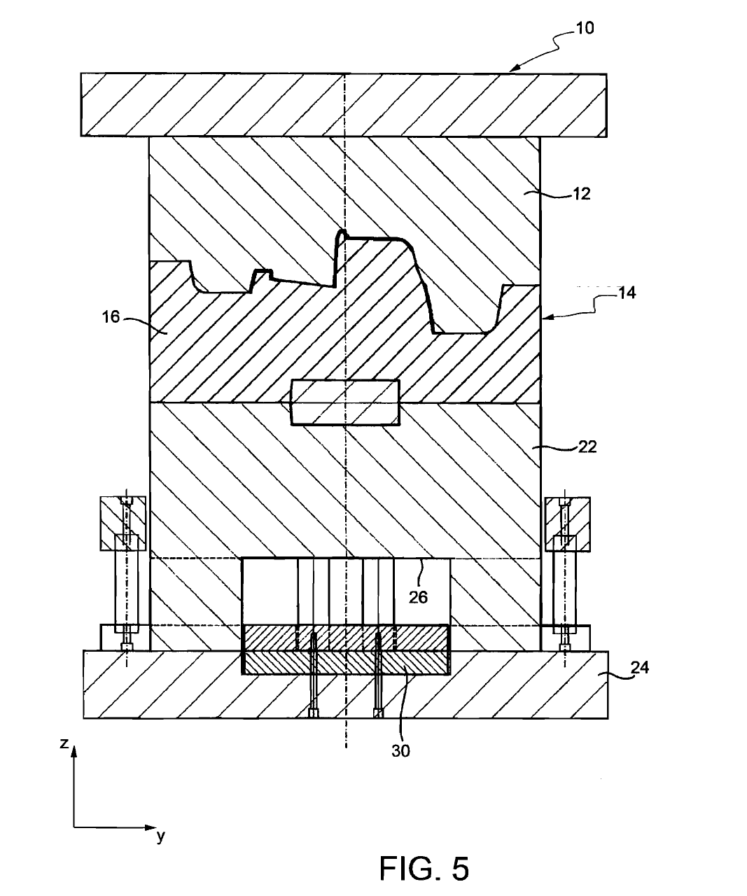

FIG. 5 shows the mould according to FIG. 3 cross-sectioned through a transverse vertical plane indicated by V-V in FIG. 3; and

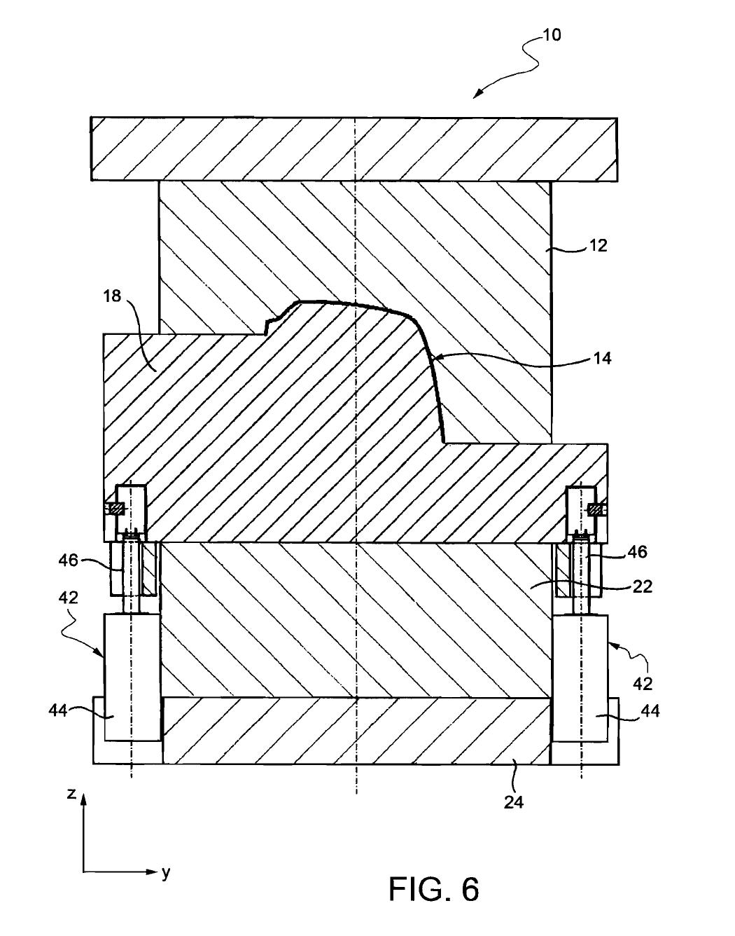

FIG. 6 shows the mould of FIG. 3 cross-sectioned through another transverse vertical plane indicated by VI-VI in FIG. 3.

In the description and the claims below, terms such as “vertical” and “horizontal” or “top” and “bottom”, are to be understood referring to the installed condition of the mould, where the mould opening/closing direction (indicated “z” in the drawings) is oriented vertically. Moreover, the terms “longitudinal” and “length” on the one hand and “transverse” and “width” on the other hand refer to a pair of horizontal directions perpendicular to each other, oriented in the direction of maximum extension (indicated “x” in the drawings) and in the direction of minimum extension of the mould (indicated “y” in the drawings), respectively.

With reference to the drawings, a mould for injection-moulding of plastic parts, in the example shown a mould for injection-moulding of motor-vehicle bumpers, is generally indicated 10 and basically comprises a die 12 and a punch 14 which define a cavity inside which the plastic material shall be injected by a press, in a manner known per se. The punch 14 comprises in turn a stationary central element 16, a first pair of movable lateral elements 18 (referred to henceforth simply as first lateral elements) arranged on longitudinally opposite sides relative to the central element 16, and a second pair of movable lateral elements 20 (referred to henceforth simply as second lateral elements) arranged on longitudinally opposite sides relative to the first lateral elements 18 and drivingly connected for translation therewith. The outer surfaces of the central element 16 and of the first and second lateral elements 18, 20 are suitably shaped so as to define, along with the die 12, the shape of the moulding cavity and therefore give to the part to be moulded the desired shape.

The mould 10 also comprises a support body 22 for supporting both the die 12 and the punch 14. The central element 16 of the punch 14 is fixed to the support body 22, while the die 12 and the first and second lateral elements 18, 20 of the punch 14 are simply rested, in the closed mould condition, on the support body 22. The mould 10 also comprises a base plate 24 on which the support body 22 is mounted. The support body 22 has, on its bottom side, a cavity 26 which is closed at the bottom by the base plate 24 so as to form a chamber inside which an extraction plate 30 (visible in FIGS. 4 and 5) is arranged in a vertically slidable manner, guided along vertical columns 28. As can be seen in particular in FIG. 4, preferably the cavity 26, and therefore the extraction plate 30, have a length (longitudinal dimension) not greater than that of the central element 16 of the punch 14. Owing to the smaller length of the cavity 26 compared to the prior art discussed in the introductory part of the present description, it is possible to reduce the projecting part of the support body 22 and therefore reduce the deformations to which the support body 22 and the central element 16 of the punch 14 are subject both as a result of their own weight and in particular as a result of the pressure exerted during moulding by the plastic material injected into the cavity formed between die 12 and punch 14.

The first lateral elements 18 of the punch 14 are slidably guided by means of suitable guides (not shown) along respective inclined lateral surfaces 32 formed partly (top part) by the central element 16 of the punch 14 and partly (bottom part) by the support body 22 to be displaced between a moulding position (shown in FIG. 4), in which these lateral elements are arranged with the respective outer surfaces aligned with the outer surface of the central element 16 so as to define with the latter the inner profile of the part to be moulded, and an ejection position (shown in FIGS. 1 and 2), in which these lateral elements are displaced upwards relative to the central element 16 for ejection of the moulded part. Each second lateral element 20 is connected to a respective first lateral element 18 by means of a longitudinal cylindrical guide 34 so as to be drivingly connected for translation with the first lateral element 18 in the vertical direction z, but free to translate relative to the first lateral element 18 in the longitudinal direction x. The second lateral elements 20 are moreover slidably guided by means of suitable guides (not shown) along respective inclined lateral surfaces 36 formed by the support body 22. The inclinations of the lateral surfaces 32 and 36 will be chosen in each case depending on the dimensions and the geometry of the undercuts of the part to be moulded and in any case may be greater than those permitted by conventional moulds.

The mould 10 also comprises a plurality of ejection members 38 which may be equally well all of the same type or different from each other (but in any case all known per se) and which are slidably arranged each inside a respective through-hole 40 which extends partly through the support body 22 and partly through the central element 16 of the punch 14. The ejection members 38 are four in number in the embodiment shown in the drawings (see in particular FIG. 4), but their number depends obviously on the specific application, in particular on the number of undercut formations which must be provided on the portion of the part to be moulded, the shape of which is defined by the outer surface of the central element 16 of the punch 14. Each ejection member 38 is connected at its bottom end to the extraction plate 30 so as to be displaced vertically in either direction along with the latter. More precisely, in the embodiment shown, the extraction plate 30 is a double plate, with a top plate 30a and a bottom plate 30b which can be moved independently of each other. In this case, some of the ejection members 38 (in the example shown the longitudinally inner members) are connected to the top plate 30a and are therefore moved together therewith, while the remaining ejection members 38 (in the example shown the longitudinally outer members) are connected to the bottom plate 30b and are therefore moved together therewith. Obviously, in the case of parts to be moulded devoid of bosses or undercuts in their central part, the ejection members, and along with them the extraction plate (be it single or double), could also be dispensed with.

Differently from the prior art discussed above, the extraction plate 30 has merely the function of moving the ejection members 38 and not also of moving the first and second lateral elements 18, 20 of the punch 14. Linear actuation devices 42 are instead provided for moving the first and second lateral elements 18, 20 of the punch 14, said devices being operatively connected to the first lateral elements 18 so as to control the movement of these elements, and together therewith that of the second lateral elements 20, between the aforementioned moulding and ejection positions. In the embodiment shown, the linear actuation devices 42 are four in number and are made as hydraulic jacks each comprising a cylinder 44 fixed to the base plate 24 and a rod 46 connected at its top end to the associated first lateral element 18. More specifically, the rods 46 of the four linear actuation devices 42 are connected at their top end to a support frame 48 (formed for example as a rectangular frame composed of four straight bars) to which the first lateral elements 18 are fixed, whereby the first lateral elements 18 are drivingly connected for translation with each other via the support frame 48. However, a different number and/or different types of linear actuation devices may obviously be envisaged with respect to those described and illustrated here.

Obviously, the principle of the invention remaining unchanged, the embodiments and the constructional details may be greatly modified with respect to that described and illustrated purely by way of a non-limiting example, without thereby departing from the scope of the invention as defined in the accompanying claims.

1-7. (canceled)

8. A mould for injection-moulding of plastic parts, comprising a die and a punch displaceable with respect to each other along an opening/closing direction (z) between a closed mould position, in which they define a cavity intended to receive plastic material injected by a press, and an open mould position, in which they are spaced from each other by an amount such as to allow ejection of the moulded plastic part,
wherein the punch comprises a stationary central element having an outer surface and a pair of lateral surfaces inclined relative to the opening/closing direction (z), as well as a pair of first movable lateral elements arranged on longitudinally opposite sides relative to the central element and having respective outer surfaces, the outer surfaces of the central element and of the first lateral elements of the punch being suitably shaped to define a profile of the plastic part to be moulded,
wherein each of the first lateral elements of the punch is slidably guided along a respective inclined lateral surface of the central element of the punch to be displaced between a moulding position, in which the outer surface of the lateral element is aligned with the outer surface of the central element, and an ejection position, in which the outer surface of the lateral element projects outwards with respect to the outer surface of the central element for ejection of the moulded part,
wherein the mould further comprises a plurality of linear actuation devices arranged to control the movement of the first lateral elements of the punch relative to the central element between the aforementioned moulding and ejection positions, and
wherein the mould further comprises a plurality of ejection members slidably received inside respective holes provided in the central element of the punch, and an extraction plate which is translatable in the mould opening/closing direction and is connected to the ejection members to control the sliding movement thereof inside the respective holes, and wherein the linear actuation devices of said mould are connected to the first lateral elements of the punch without the extraction plate being arranged in between.

9. The mould of claim 8, wherein the linear actuation devices are hydraulic jacks.

10. The mould of claim 8, wherein the linear actuation devices each comprise a respective expulsion member movable in a direction parallel to the opening/closing direction (z).

11. The mould of claim 10, further comprising a support frame to which the first lateral elements are fixed, the expulsion members of the linear actuation devices being each connected to the support frame so as to be drivingly connected to each other in a movement along the opening/closing direction (z).

12. The mould of claim 8, wherein the punch further comprises a pair of second lateral elements arranged on longitudinally opposite sides with respect to the first lateral elements, wherein each second lateral element is connected to a respective first lateral element so as to be drivingly connected for translation with the latter in the opening/closing direction (z), but free to translate relative to the latter in a longitudinal direction (x) of the mould.

13. The mould of claim 8, further comprising a base plate and a support body mounted on the base plate to support, in the closed mould condition, both the punch and the die, the support body and the base plate enclosing a chamber inside which the extraction plate is arranged.

14. The mould of claim 13, wherein the length or longitudinal dimension of the chamber is not greater than that of the central element of the punch.
